(19) United States
(12) Patent Application Publication
(10) Pub. No.: US 2023/0246195 A1
(43) Pub. Date: Aug. 3, 2023

(54) INORGANIC BINDERS FOR IMPROVED ANODES IN RECHARGEABLE ALKALI METAL ION BATTERIES

(71) Applicant: Novonix Battery Technology Solutions Inc., Dartmouth (CA)

(72) Inventors: Mark Nikolas Obrovac, Halifax (CA); Congxiao Wei, Halifax (CA); Scott Young, London (GB)

(21) Appl. No.: 18/296,945

(22) Filed: Apr. 6, 2023

Related U.S. Application Data
(63) Continuation of application No. PCT/US2021/051519, filed on Sep. 22, 2021.
(60) Provisional application No. 63/088,631, filed on Oct. 7, 2020.

(51) Int. Cl. H01M 4/62; H01M 4/38; H01M 4/04; H01M 4/134

(52) U.S. Cl. CPC H01M 4/622; H01M 4/386; H01M 4/0404; H01M 4/134; H01M 2004/027

(57) ABSTRACT

Inorganic binders comprising silicon or phosphorus have been discovered that offer advantages for use in rechargeable alkali metal ion battery anodes. These improved anodes are less hydrophilic and not subject to the deformation that can occur in conventional anodes from water absorption even at dry room levels. However, the performance characteristics in batteries is comparable to or even better than that obtained from conventional anodes. Also advantageously, these anodes can be prepared from aqueous slurries.

### TECHNICAL FIELD

The present invention pertains to the binders used in preparing anodes for rechargeable alkali metal ion batteries, and particularly in preparing anodes with copper foil current collectors for lithium ion batteries.

### BACKGROUND

The development of rechargeable high energy density batteries, such as lithium ion (Li-ion) batteries, is of great technological importance. Conventional Li-ion batteries utilize graphite as the negative electrode or anode active material. During cell operation, lithium reversibly inserts into graphite via an intercalation mechanism. Other active materials that can form alloys with lithium am known that can store much more lithium per unit weight and volume than graphite. Such active materials that can form alloys with lithium include Si, Sn, Al, Zn, Mg, Sb, Bi, Pb, Cd, Ag, Au, and amorphous carbon (active elements); alloys of active elements; and alloys of active elements with other elements.

Exemplary active materials that can form alloys with lithium include Si, SiO, alloys of silicon that include transition metals, and alloys of tin that include transition metals. In contrast with graphite, the lithiation/dilithiation of active materials that can form alloys with lithium occurs via a non-intercalation alloying process.

Li-ion batteries that include active materials that can form alloys with lithium in their negative electrode are however often prone to loss of capacity during cycling or capacity fade. This is because active materials that can form alloys with lithium undergo large volume expansion/contraction during lithiation/dilithiation. The volume expansion can be up to 300%. This volume expansion can disrupt the solid electrolyte interphase (SEI) which serves to passivate active material surfaces from reaction with the electrolyte. As a result, active materials that can form alloys with lithium often continually react with electrolyte during normal cell operation, leading to capacity fade, electrolyte depletion and cell failure.

The use of conventional non-functionalized binders, such as polyvinylidene difluoride (PVDF), as binders for anodes containing active Si-alloy materials is known to result in exceedingly poor performance. Such binders do not form bonds with the active materials and therefrom do not have the ability to maintain electrical contact with the Si-alloy materials, especially during dilithiation, when the Si-alloys contract in size. This effect leads to capacity fade during cycling.

In addition, such non-functionalized binders do not efficiently coat Si-alloy surfaces, leaving them exposed to react with electrolyte. This effect leads to capacity fade during cycling.

In order to improve the performance of Li-ion batteries that include active materials that can form alloys with lithium, special binders are often used. According to [M. N. Obrovac, “Si-alloy negative electrodes for Li-ion batteries”, Current Opinion in Electrochemistry 9 (2018) 8-17], there are only two classes of binders known in which anodes containing Si-alloys can cycle well: functionalized aliphatic binders (FABs) and aromatic binders (ABs). According to this reference FABs are organic binders that can “bond to native silicon oxide (Si —O —Si) and silanol (Si —OH) groups on silicon surfaces with either strong ester-like covalent bonds or weaker hydrogen bonds. FABs include aliphatic polymers and molecules containing carboxyl groups, including poly(acrylic acid), lithium polyacrylate, sodium polyacrylate, sodium carboxymethyl cellulose, alginate, and citric acid. ABs that perform well as binders in active Si-alloy containing anodes are believed to reduce to carbon during the first lithiation of the anode, resulting in the formation of “a carbon coating around the alloy particles, improving electronic contact and reducing electrolyte decomposition”. Examples of known ABs include polyimide (PI) and phenolic resin (PR). Carbon formed by the thermal decomposition of organic precursors has also been found to be an effective binder for anodes containing active Si-alloys [T. D. Hatchard, RA. Fielden, and M. N. Obrovac, “Sintered polymeric binders for Li-ion battery alloy anodes”, Canadian Journal of Chemistry 96 (2018) 765-770]. Thus all binders known to be useful for Li-ion battery anodes which include Si-alloy active materials are functionalized organic molecules; aromatic organic molecules; and carbon formed as the decomposition products of organic molecules.

Many undesirable problems remain with conventional binders for such battery electrodes. Some conventional binders, e.g. polyimides, can be expensive. Further, some of the conventional binders are hydrophilic, which can make electrode processing difficult. For instance, commercial Li-ion batteries are typically manufactured by winding electrode webs together into cylindrical or prismatic “jellyroll” assemblies in low humidity dry rooms. However, such hydrophilic binders can absorb sufficient water over time—even from the low humidity atmosphere in these dry rooms—to result in deformation of the electrodes from expansion (e.g. “curling” or “scrolling” of the webs) and prevent acceptable winding. Further still, in some instances electrode coatings using conventional binders have poor adhesion to current collectors. In addition, conventional binders are typically used in small amounts, such that they form thin layers (˜20 nm) on active material surfaces. Thicker layers of binder can impede cell performance by reducing ion diffusion.

In U.S. Pat. No. 5,856,045, secondary electrochemical cells, and more particularly, to lithium ion electrochemical cells are disclosed with an inorganic binder and an associated process for fabrication of same. A binder material is mixed with an active material for eventual application onto the surface of a first and/or second electrode. The binder material is soluble with the active material yet insoluble with respect to the associated organic electrolyte. Alloys are not mentioned as possible active materials.

In U.S. Ser. No. 10/388,467, the long-term cycle performance of a lithium-ion battery or a lithium-ion capacitor is improved by minimizing the decomposition reaction of an electrolyte solution and the like a a side reaction of charge and discharge in the repeated charge and discharge cycles of the lithium-ion battery or the lithium-ion capacitor. A current collector and an active material layer over the current collector are included in an electrode for a power storage device. The active material layer includes a plurality of active material particles and silicon oxide. The surface of one of the active material particles has a region that is in contact with one of the other active material particles. The surface of the active material particle except the region is partly or entirely covered with the silicon oxide.

In US20170117586, electrolyte compositions are disclosed containing a non-fluorinated carbonate, a fluorinated solvent, a cyclic sulfate, at least one lithium borate salt selected from lithium bis(oxalato)borate, lithium difluoro(oxalato)borate, lithium tetrafluoroborate, or mixtures thereof, and at least one electrolyte salt. The electrolyte composition may further comprise a fluorinated cyclic carbonate. The electrolyte compositions are useful in electrochemical cells, such as lithium ion batteries.

In US20160344032, a battery is provided including a positive electrode, a negative electrode, and an electrolyte layer between the positive electrode and the negative electrode. At least one of the positive electrode and the negative electrode includes at least one kind of an inorganic binder that includes an oxide of at least one kind of element selected from the group including bismuth (Bi), zinc (Zn), boron (B), silicon (Si) and vanadium (V). Alloys are not mentioned as possible active materials.

Despite the continuing and substantial global effort directed at simplifying the manufacture of, improving the performance of, and reducing the cost of rechargeable batteries, further improvements are still desired in all these areas. The present invention addresses these needs and provides further benefits as disclosed below.

### SUMMARY

It has been found that certain inorganic polymers and molecules comprising silicon and/or phosphorus can function exceedingly well as the sole binder in anodes for alkali-metal ion batteries, and particularly Li-ion batteries, which include active materials that can form alloys with lithium.

Exemplary inorganic binders include polysilicates, polyphosphates and phosphates, including lithium polysilicate, sodium polyphosphate, and lithium phosphate monobasic.

These binders can allow for the use of aqueous slurries in anode preparation and yet are less hydrophilic and less susceptible to deformation when exposed to water vapour. In particular, they are more mechanically stable during battery manufacturing operations, e.g. winding, in a dry room.

It was furthermore found that certain of these inorganic binders form thick layers around the active materials that are greater than 100 nm and, in some embodiments, greater than 500 nm, while maintaining good electrode kinetics. Without being bound to theory, it is believed that such thick binder layers may beneficially reduce electrolyte reactivity on the underlying active materials that can form alloys with lithium by impeding the diffusion of electrolyte towards active material surfaces.

Specifically, anodes of the invention are for a rechargeable alkali metal ion battery comprising an electrochemically active anode powder material that can alloy with the alkali metal of the rechargeable alkali metal ion battery. The anodes further comprise a binder comprising an inorganic compound comprising silicon or phosphorus and a metal current collector.

The invention is particularly suitable for use in lithium ion batteries in which the alkali metal is lithium. It is also particularly suitable for use in anodes in which the electrochemically active anode powder material comprises silicon, tin, or aluminum.

In embodiments in which the electrochemically active anode powder material comprises silicon, the material can itself be an alloy of silicon and a transition metal. In other embodiments, the anode may additionally comprise an additional electrochemically active anode powder material comprising graphite.

The inorganic compound in the binder comprises silicon and/or phosphorus and may also comprise boron. In exemplary embodiments, the inorganic compound is a polysilicate, polyphosphate or phosphate, e.g. lithium polysilicate, sodium polyphosphate or lithium phosphate monobasic respectively.

An advantage of the invention is that the inorganic compound can be soluble in water and thus is more environmentally friendly more manufacturing purposes than are binders requiring non-aqueous solvents. Further, the inorganic compounds can be much less hydrophilic than conventional binders, e.g. such as lithium polyacrylate, and can thus be less prone to deformation or curling up during storage or during spooling or winding operations in dry room atmospheres.

As mentioned above, these binders can function exceedingly well as the sole binder in alkali metal ion battery anodes, i.e. anodes in which the binder consists essentially of the inorganic compound. Further, these binders are suitable for anodes in which the metal current collector is bare copper foil, particularly bare electrolytic copper foil.

As demonstrated in the Examples below, suitable ratios of binder to electrochemically active anode powder material by weight can be in the range from about 0.03 to 0.55. Further, exemplary embodiments were made in which the binder coats the electrochemically active anode powder material with a coating greater than 10 nm in thickness.

Methods of making the aforementioned anodes include methods that are essentially similar to conventional methods but for the choice of binder. That is, a suitable method comprises the steps of: obtaining an electrochemically active powder material that can alloy with the alkali metal of the rechargeable alkali metal ion battery lithium, a binder comprising an inorganic compound, and a metal current collector, making a slurry comprising the electrochemically active powder material, the binder, and a solvent for the binder, coating the slurry onto the metal current collector, and removing the solvent.

### BRIEF DESCRIPTION OF THE DRAWINGS

FIG. 1a shows a pristine cross-sectional backscattered SEM image of a prior art lithium ion anode of Prior Art Example 1 made with lithium polyacrylate binder.

FIG. 1b shows the electrochemical performance (discharge capacity retention vs. cycle number) of the prior art lithium ion anode of FIG. 1a as measured in a half-cell.

FIG. 2a shows a pristine cross-sectional backscattered SEM image of the lithium ion anode of Example 1 made with lithium polysilicate binder.

FIG. 2b shows the electrochemical performance (discharge capacity retention vs. cycle number) of the lithium ion anode of Example 1 as measured in a half-cell. Shown for comparison is the electrochemical performance of a half-cell made with a prior art lithium ion anode of Prior Art Example 1.

FIG. 3a shows a pristine cross-sectional backscattered SEM image of the lithium ion anode of Example 2 made with sodium hexametaphosphate binder.

FIG. 3b shows the electrochemical performance (discharge capacity retention vs. cycle number) of the lithium ion anode of Example 2 as measured in a half-cell. Shown for comparison is the electrochemical performance of a half-cell made with a prior art lithium ion anode of Prior Art Example 1.

FIG. 4a shows a pristine cross-sectional backscattered SEM image of the lithium ion anode of Example 3 made with lithium phosphate monobasic binder.

FIG. 4b shows the electrochemical performance (discharge capacity retention vs. cycle number) of the lithium ion anode of Example 3 as measured in a half-cell. Shown for comparison is the electrochemical performance of a half-cell made with a prior art lithium ion anode of Prior Art Example 1.

FIG. 5 shows the electrochemical performance (discharge capacity retention vs. cycle number) of a half-cell made with a prior art lithium ion anode of Prior Art Example 2.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

In addition, the following definitions are to be applied throughout the specification: The term “alkali metal ion battery” refers to both an individual alkali metal ion cell or to an army of such cells that are interconnected in a series and/or parallel arrangement. Each such cell comprises anode and cathode electrode materials in which ions of the alkali metal can be reversibly inserted and removed.

The term “anode” refers to the electrode at which oxidation occurs when an alkali metal ion battery is discharged. In a lithium ion battery, the anode is the electrode that is delithiated during discharge and lithiated during charge.

The term “cathode” refer to the electrode at with reduction occurs when an alkali metal ion battery 35 is discharged. In a lithium ion battery, the cathode is the electrode that is lithiated during discharge and delithiated during charge.

Herein, the term “electrochemically active anode powder material” refers to a powder material that can electrochemically react or alloy with an alkali metal at typical anode potentials in a relevant electrochemical device. In a lithium ion battery, anode materials are lithiated during charge and delithiated during discharge typically over potentials from 0 to 2 V vs. U. For instance, Si, Sn, and Al powder materials are electrochemically active powder materials in the context of a lithium ion battery.

The definition of the term “inorganic compound” and the distinction between an “inorganic compound” and an “organic compound” is not fully agreed upon in the art. Herein, “inorganic compound” is intended to include any chemical compound that contains no carbon atoms and also any chemical compound containing one or more carbon atoms but lacking both C—H bonds and C—C bonds.

The term “half-cell” refer to a cell that has a working electrode and a metal counter/reference electrode. A lithium half-cell has a working electrode and a lithium metal counter/reference electrode.

In a Li half-cell, anode materials are delithiated during charge and lithiated during discharge at potentials less than 2 V vs. Li.

In a quantitative context, the term “about” should be construed as being in the range up to plus 10% and down to minus 10%.

In the present invention, certain inorganic compounds have been identified that are advantageous for use as binders for anodes of rechargeable alkali metal ion batteries, and particularly for anodes in typical lithium ion batteries. Such compounds can serve as the sole binder in these anodes and provide improved mechanical properties while still providing for competitive or even improved performance in battery operation. For instance, these inorganic compounds are less hydrophilic than conventional state-of-the-art anode binders and are less susceptible to expansion and deformation when exposed to water vapour. As a result, web electrodes made with these binders are more stable and less prone to curling in dry roam environments which is very important for manufacturing purposes. Desirably however, such binders can be quite soluble in water thus desirably allowing for the use of aqueous slurries in the preparation of anodes. Further, certain inorganic binders have been found to allow for good anode kinetics in battery operation even though thick layers (e.g. >100 nm) had been formed around the active materials. In turn, this may improve battery lifetime by reducing reactions with the electrolyte.

In a general embodiment of the invention, the anode at least comprises an electrochemically active anode powder material that can alloy with the alkali metal of the rechargeable alkali metal ion battery and an inorganic compound as binder which together are applied to a metal current collector.

Inorganic compounds suitable for use in the invention are those known to hydrolyze in water to form hydroxyl groups. In some embodiments such inorganic compounds can comprise silicon or phosphorus.

In an exemplary anode embodiment intended for use in lithium ion batteries, the alkali metal involved is lithium and the electrochemically active anode powder material is one that can alloy with lithium, such as silicon, tin, or aluminum. The electrochemically active anode powder material can also include alloys itself, for instance alloys of silicon and a transition metal. Further, the anode can contain additional electrochemically active anode powder materials, such as graphite.

Suitable inorganic binders include polysilicates, polyphosphates and phosphates, such as lithium polysilicate, sodium polyphosphate, and lithium phosphate monobasic respectively which have been employed successfully in the Examples below.

As those skilled in the art will appreciate, the optimum choice of binder type and the relative amount to be used can be expected to vary somewhat in accordance with the type of and amount of the other anode components involved. It is expected that those of ordinary skill will readily be able to determine appropriate choices for binder types and amounts using the below Examples as a guide and minimal experimentation. For instance, for V7 Si alloy active anode powder material on bare electrolytic copper foil, and using one of the aforementioned binder choices in the Examples, binder amounts by weight in the range from about 0.11 to 0.55 can be expected to be appropriate and can desirably result in coatings greater than 100 nm in thickness on the active alloy anode powder.

Once a suitable binder type and amount are selected for a given anode construction, anodes and rechargeable alkali ion batteries employing those anodes may be prepared in various ways known to those in the art. In particular, anodes can be made in a standard commercial manner by first obtaining all the appropriate components, then making a slurry comprising the electrochemically active powder material, the binder, and an appropriate solvent for the binder, then coating the slurry onto the metal current collector, and finally removing the solvent (e.g. by drying). Desirably, suitable inorganic compound binders can be soluble in water and thus the difficulties associated with toxic or flammable solvents can be avoided in manufacture.

In this way, improved anodes of the invention can be prepared in which the binder consists essentially of the inorganic compound (i.e. the inorganic compound is the sole binder in the anode). Further, no special treatment (e.g. roughening) of the current collector may be necessary nor no additional additives required in order to obtain acceptable adhesion thereto. Thus, the invention may successfully be employed, with no extra treatment nor additives, to prepare anodes on the bare electrolytic copper foils that are typically used commercially. In some embodiments, additives may be used in conjunction with the inorganic binders of the invention to improve slurry viscosity and coating quality. Such additives include thickeners, such as carboxymethyl cellulose.

Without being bound to theory, it is believed that hydroxyl groups on hydrated inorganic binders can react with the hydroxyl groups on metal and metal alloy surfaces to form [metal-O-organic binder]type bonds. It is believed that the formation of such bonds can confer good mechanical properties to the anode. It is also believed that the formation of such bonds results in the formation of a continuous binder coating on the active alloy particles that can protect the active alloy particles from reacting with the electrolyte during cell operation and leading to good cycling performance.

The following examples are illustrative of certain aspects of the invention but should not be construed as limiting the invention in any way. Those skilled in the art will readily appreciate that other variants are possible for the inorganic binders used, the anode structures made, the methods employed, and the type of rechargeable alkali metal ion batteries they are intended for.

### Examples

Exemplary anodes of the invention were prepared using silicon alloy powder material and several different binder materials. An anode representative of the state of the conventional art was also prepared using lithium polyacrylate binder for comparison purposes. Certain characteristics of the prepared anodes were determined and some performance results were obtained from half-cell measurements. Unless otherwise specified, in all cases the following preparatory and analytical methods were used.

### Cross-Sectional SEM

Cross sections of anode samples were prepared with a JEOL Cross-Polisher (JEOL Ltd., Tokyo, Japan) which sections samples by shooting argon ions at them. Cross-sectional anode morphologies were studied and images obtained with a TESCAN MIRA 3 LMU Variable Pressure Schottky Field Emission Scanning Electron Microscope (SEM).

### Cell Preparation

Example anode electrodes were assembled in laboratory test lithium half-cells, namely 2325-type coin cells with a lithium foil (99.9%, Sigma Aldrich) counter/reference electrode. (Note: as is well known to those skilled in the art, results from these test lithium half-cells allow for reliable prediction of anode materials performance in lithium ion batteries.) Two layers of Celgard 2300 separator and one layer of blown microfiber (3M company) were used as separators. Each coin cell contained two Cu spacers to guarantee proper internal pressure. 1M LiPF₆ (BASF) in a solution of ethylene carbonate, diethyl carbonate and monofluoroethylene carbonate (volume ratio 3:6:1, all from BASF) was used as electrolyte. Cell assembly was carried out in an Ar-filled glove box. Cells were cycled galvanostatically at 30.0±0.1° C. between 0.005 V and 0.9 V for the first two cycles with a C/10 and a C/40 trickle discharge at 0.005 V and the following cycles with a rate of C/5 and a C/20 trickle discharge at 0.005V using a Maccor Series 4000 Automated Test System. Electrochemical performance for each anode was then plotted as discharge capacity retained versus cycle number.

### Prior Art Example 1 (Si-Alloy Anode with Lithium Polyacrylate Binder)

An anode slurry was prepared by mixing 0.5 g Si alloy powder (3M L-20772 V7 Si alloy, hereafter called V7, from 3M Co., St. Paul, Minn.) and 0.56 g of 10 wt % aqueous lithium polyacrylate solution. The lithium polyacrylate solution had been prepared by neutralizing polyacrylic acid (M_{w}=250,000, Sigma-Aldrich) solution with lithium hydroxide (LiOH·H₂O, ≥98% Sigma-Aldrich) solution. The slurry was mixed for 10 minutes with a Mazenrstar mixer at 5000 rpm and then spread onto bare electrolytic copper foil (Funrkawa Electric, Japan) with a 0.004 inch gap coating bar. The coating was then dried in air for 1 hour at 120° C., cut into 1.3 cm² anode disks and then heated under vacuum overnight at 120° C. The obtained coating showed excellent adhesion with the foil, as no cracking or peeling of the coating was observed. However, the foil curled concave on the coated side of the foil, due to shrinkage of the coated layer during the drying process. This made cell construction difficult.

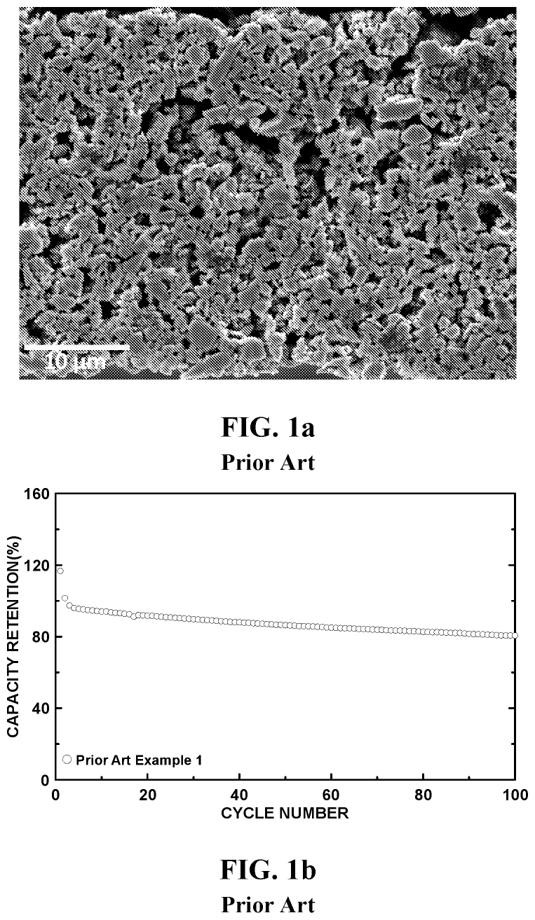

FIG. 1a shows a cross-sectional backscattered SEM image of a pristine one of these prior art lithium ion anodes. A laboratory test cell was then assembled using another anode sample as described above and cycle tested. FIG. 1b shows the electrochemical performance (discharge capacity retention vs. cycle number) of this prior art lithium ion anode. After cycle testing was completed (i.e. 100 cycles), the anode was removed and a cross-sectional backscattered SEM image of this post-cycled prior art anode was obtained. Significant erosion of the Si alloy surface was observed.

### Example 1 (Si-Alloy Anode with Lithium Polysilicate Binder)

An anode slurry was then prepared in a like manner to the preceding except using lithium polysilicate binder. Here, the slurry was prepared by mixing 0.8 g 3M V7 Si alloy powder and 0.44 g lithium polysilicate solution (20 wt % in H₂O, Sigma-Aldrich) in 0.65 mL distilled water. Again, the obtained coating showed excellent adhesion with the foil as no cracking or peeling of the coating was observed. This coating did not curl or deform in any noticeable way during the drying process.

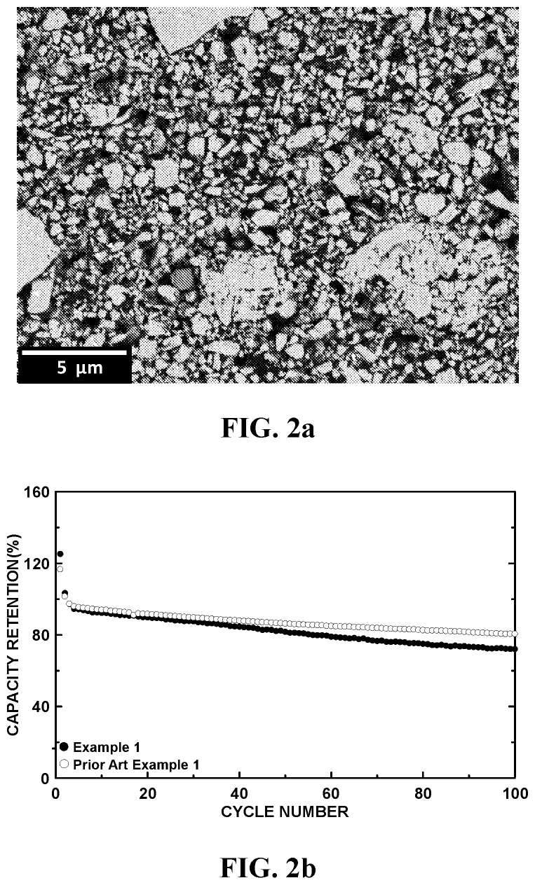

FIG. 2a shows a pristine cross-sectional backscattered SEM image of one of the lithium ion anodes made here. FIG. 2b compares the electrochemical performance of a half-cell comprising one of these inventive Example 1 anodes to the aforementioned Prior Art Example. The latter is slightly better but the results are comparable and acceptable.

### Example 2 (Si-Alloy Anode with Sodium Polyphosphate Binder

Another anode slurry was prepared in a like manner to the preceding except using sodium polyphosphate binder. This slurry was prepared by mixing 1 g 3M V7 Si alloy powder and 0.11 g sodium polyphosphate powder (sodium hexametaphosphate, 65-70% P₂O₅ basis, Sigma-Aldrich) in 1 mL distilled water. Again the obtained coating showed excellent adhesion with the foil as no cracking or peeling of the coating was observed. This coating did not curl or deform in any noticeable way during the drying process.

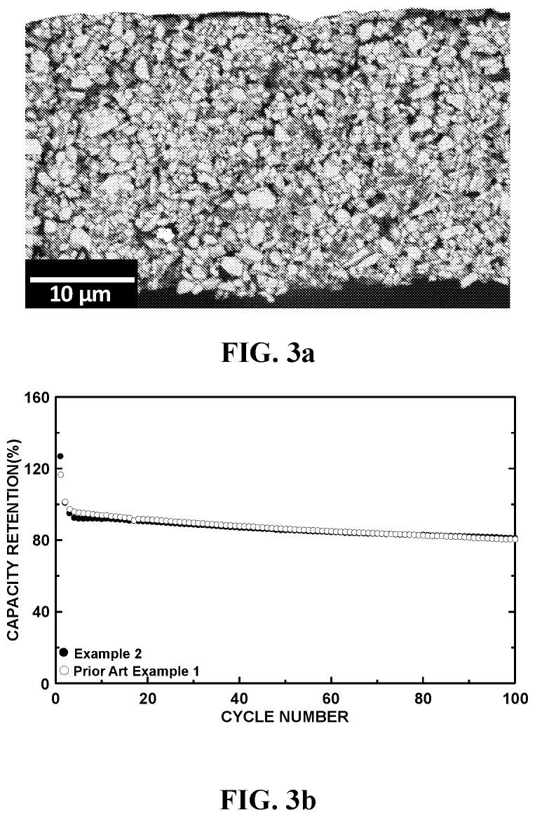

FIG. 3a shows a pristine cross-sectional backscattered SEM image of one of the lithium ion anodes made here. Here the inorganic binder was observed to have formed a coating on the Si alloy particles that was about 500 nm thick.

FIG. 3b compares the electrochemical performance of a half-cell comprising one of these inventive Example 2 anodes to the aforementioned Prior Art Example. Here the results are virtually indistinguishable.

### Example 3 (Si-Alloy Anode with Lithium Phosphate Monobasic Binder)

Another anode slurry was prepared in a like manner to the preceding except using lithium phosphate monobasic_binder. This slurry was prepared by mixing 1 g 3M V7 Si alloy powder and 0.11 g lithium phosphate monobasic powder (99%, Sigma-Aldrich) in 1 mL distilled water. Again, the obtained coating showed excellent adhesion with the foil as no cracking or peeling of the coating was observed. This coating did not curl or deform in any noticeable way during the drying process.

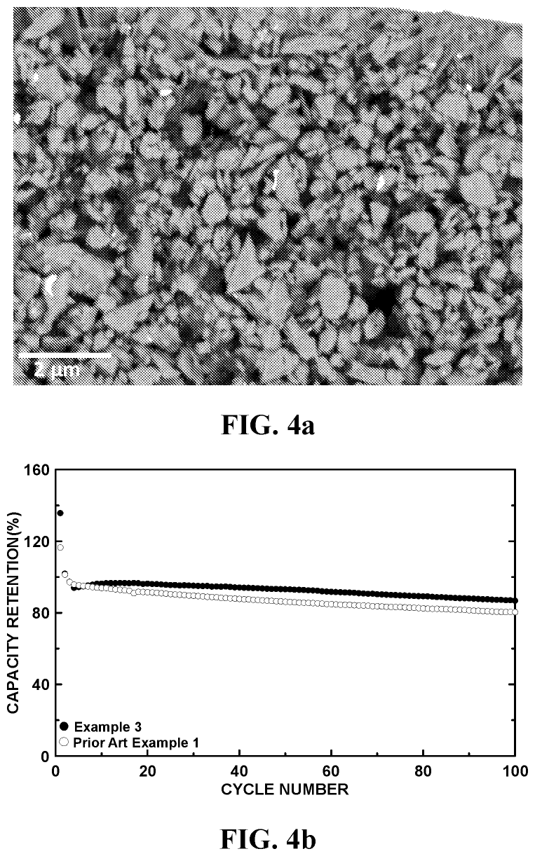

FIG. 4a shows a pristine cross-sectional backscattered SEM image of one of the lithium ion anodes made here. FIG. 4b compares the electrochemical performance of a half-cell comprising one of these inventive Example 3 anodes to the aforementioned Prior Art Example. Here, the results for the inventive anode are slightly better than those for the state of the art Prior art Example.

As is evident from the above, the cell performance results are essentially the same or better for all the inventive binders tested, compared to the prior art example. Further, all the anodes made with these inorganic binders were less hydrophilic and less sensitive to exposure to water vapour compared to the prior art example—showing no deformation during the drying process.

### Prior Art Example 2

Another anode slurry was prepared in a like manner to the preceding except using PVDF binder (average Mw˜534,000 by GPC, powder, Sigma-Aldrich) and N-methyl-2-pyrrolidone (NMP, Sigma-Aldrich, anhydrous 99.5%) was used instead of water. This slurry was prepared by mixing 1 g 3M V7 Si alloy powder and 0.11 g PVDF in 1 mL NMP. The obtained coating showed excellent adhesion with the foil as no cracking or peeling of the coating was observed. This coating did not cur or deform in any noticeable way during the drying process.

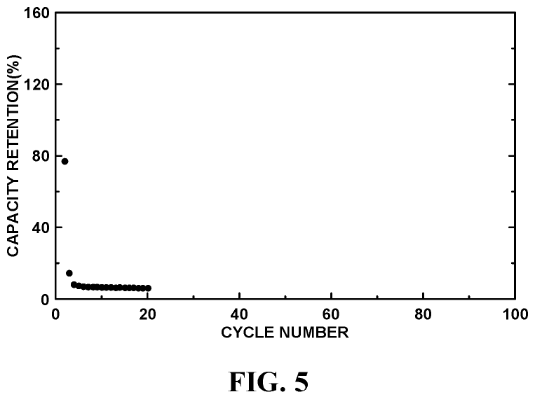

FIG. 5 shows electrochemical performance of a half-cell comprising one of these prior art anodes. The cell suffers from almost complete loss of capacity after the first lithiation of the anode. This performance is typical of binders that do not fall into the two classes of known binders (FABs or ABs) or carbonized binders discussed in the introduction.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, while the examples focused on anodes for lithium ion batteries, it is expected that similar advantages may be obtained in anodes for any type of alkali metal ion battery. Such modifications are to be considered within the purview and scope of the claims appended hereto.

1. An anode for a rechargeable alkali metal ion battery comprising:
an electrochemically active anode powder material that can alloy with the alkali metal of the rechargeable alkali metal ion battery;
a binder comprising an inorganic compound comprising silicon or phosphorus; and
a metal current collector,
wherein the binder consists essentially of the inorganic compound.

2. The anode of claim 1 wherein the alkali metal is lithium.

3. The anode of claim 1 wherein the electrochemically active anode powder material comprises silicon, tin, or aluminum.

4. The anode of claim 3 wherein the electrochemically active anode powder material comprises silicon.

5. The anode of claim 4 wherein the electrochemically active anode powder material is an alloy of silicon and a transition metal.

6. The anode of claim 4 comprising an additional electrochemically active anode powder material comprising graphite.

7. The anode of claim 4 wherein the inorganic compound comprises boron.

8. The anode of claim 7 wherein the inorganic compound is a polysilicate, polyphosphate or phosphate.

9. The anode of claim 8 wherein the inorganic compound is lithium polysilicate, sodium polyphosphate or lithium phosphate monobasic.

10. The anode of claim 1 wherein the inorganic compound is soluble in water.

11. The anode of claim 1 wherein the ratio of binder to electrochemically active anode powder material by weight is in the range from about 0.03 to 0.55.

12. The anode of claim 1 wherein the binder coats the electrochemically active anode powder material with a coating greater than 10 nm in thickness.

13. The anode of claim 1 wherein the metal current collector is bare copper foil.

14. A rechargeable alkali metal ion battery comprising the anode of claim 1.

15. A method of making an anode for a rechargeable alkali metal ion battery comprising:
obtaining an electrochemically active powder material that can alloy with the alkali metal of the rechargeable alkali metal ion battery lithium, a binder comprising an inorganic compound, and a metal current collector;
making a slurry comprising the electrochemically active powder material, the binder, and a solvent for the binder;
coating the slurry onto the metal current collector; and
removing the solvent,
wherein the binder consists essentially of the inorganic compound.

16. The method of claim 15 wherein the alkali metal is lithium.

17. The method of claim 15 wherein the electrochemically active material comprises silicon, tin, or aluminum.

18. The method of claim 15 wherein the inorganic compound is a polysilicate, polyphosphate or phosphate.

19. The method of claim 15 wherein the solvent is water.
